(19) United States
(12) Patent Application Publication
(10) Pub. No.: US 2026/0198755 A1
(43) Pub. Date: Jul. 16, 2026

(54) CLEANING TOOL

(71) Applicant: Evan Whelan, Fort Lauderdale, FL (US)

(72) Inventor: Evan Whelan, Fort Lauderdale, FL (US)

(21) Appl. No.: 19/441,532

(22) Filed: Jan. 6, 2026

Related U.S. Application Data
(60) Provisional application No. 63/743,988, filed on Jan. 10, 2025.

(51) Int. Cl. A47L 25/08; B25G 1/10

(52) U.S. Cl. CPC A47L 25/08; B25G 1/102

(57) ABSTRACT

A laundry cleaning tool includes an elongated body with grip-enhancing recesses along a handle portion. The tool features a bulbous nose at one end for accessing curved surfaces like shoe interiors, and a bullet-hooked nose extending perpendicular from the opposite end for reaching confined spaces around seams, buttons, and garment closures. A magnet recessed within the body enables convenient storage on metal household surfaces. The tool may be used with a complementary diamond-shaped backing plate that inserts into tubular garment sections like sleeves or pant legs. The plate provides a rigid surface against which either tool end can press fabric during stain treatment, preventing fabric deflection while working detergent into stained areas. A second magnet in the plate enables magnetic attachment to the tool for unified storage.

### CROSS-REFERENCE TO RELATED APPLICATIONS

The present application claims priority to U.S. Provisional Application No. 63/743,988 filed Jan. 10, 2025, titled “CLEANING TOOL,” which is hereby incorporated by reference in its entirety.

### TECHNICAL FIELD

The embodiments disclosed herein generally relate to laundry cleaning tools, and more specifically to handheld devices for applying detergents and removing stains from garments and shoes.

### BACKGROUND

Stain removal from clothing and fabrics typically involves applying cleaning agents to affected areas and manually working the detergent into the material through rubbing or scrubbing motions. This process often requires direct hand contact with stained fabrics or the use of basic implements such as brushes or cloths. While these methods can be effective for surface-level stains, they present challenges when addressing stains in difficult-to-access areas of garments or when working with delicate materials that require careful handling.

Traditional stain removal tools designed for laundry applications have included soap-like products in stick form, often formulated with natural ingredients such as coconut oil, vegetable oils, or borax. These products enable users to apply concentrated cleaning agents directly to stained areas before washing. Other conventional approaches include the use of chemically-neutral implements that enables detergents to be worked into fabrics without risk of adverse chemical reactions between the tool material and the cleaning agents or fabric dyes.

Specialized tools used in professional garment care settings, such as bone sticks employed by dry cleaning establishments, provide rigid surfaces for working cleaning agents into fabrics. These implements typically feature single-purpose designs optimized for specific stain removal techniques used in commercial settings. However, such tools generally serve limited functions and may not address the diverse stain removal challenges encountered in household laundry applications.

The manual nature of conventional stain removal processes can be time-consuming and may result in incomplete stain removal when users cannot effectively access all areas of a garment. Certain garment configurations, such as the interior portions of shoes, tight seams, pockets, or areas around closures, present accessibility challenges that limit the effectiveness of traditional stain removal approaches. Additionally, conventional methods typically require users to manage multiple separate tools or implements to address different stain removal scenarios, increasing complexity and storage requirements.

Consequently, there is a need for an improved laundry cleaning tool that provides enhanced accessibility to difficult-to-reach areas of garments and shoes while offering multiple functional capabilities in a single integrated implement that can be conveniently stored and readily accessed for household stain removal applications.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

In one aspect, variations of the disclosed laundry cleaning tool may include an elongated handheld implement comprising specialized end configurations and integrated grip features. The tool comprises an elongated body with distinct functional ends positioned opposite one another, ergonomic gripping surfaces, and magnetic attachment capabilities. The multiple functional end configurations enable controlled access to various garment areas including shoe interiors, seams, and other confined spaces while providing different surface geometries optimized for specific stain removal applications, eliminating the need for multiple separate implements while providing convenient magnetic storage options on common household metal surfaces.

In one aspect, variations of the disclosed laundry cleaning system may include a two-piece configuration with complementary tool and backing plate components. The system incorporates an elongated tool with multiple functional ends for applying and working detergents into fabrics, combined with a insertable backing plate that provides rigid support during stain removal operations. The integrated magnetic attachment between components enables secure storage in a single unit while the plate component facilitates stain removal in tubular garment sections such as sleeves and pant legs by providing a firm backing surface against which the tool can effectively work cleaning agents into fabric fibers.

In one aspect, variations of the disclosed method of stain removal may include positioning backing support within garments and applying cleaning agents using multi-functional tool ends. The method involves inserting a rigid backing plate within garment sections to provide support surfaces, applying detergent to stained areas, and working the cleaning agent into fabric using specialized tool end configurations selected based on the specific access requirements of the stained area. The operation process enables effective stain treatment in previously difficult-to-access locations through the combination of internal support and externally applied tool manipulation, improving stain removal effectiveness while reducing the time and effort required compared to conventional manual stain treatment methods.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a side view of a laundry cleaning tool, according to some embodiments;

FIG. 2 illustrates a perspective view of the laundry cleaning tool of FIG. 1, according to some embodiments;

FIG. 3 illustrates a perspective view of a cleaning tool plate, according to some embodiments;

FIG. 4 illustrates a top view of the cleaning tool plate of FIG. 3, according to some embodiments; and

FIG. 5 illustrates a flowchart showing the method of stain removal using the laundry cleaning tool and cleaning tool plate, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

For clarity and consistency, the same reference numerals will be used throughout the detailed description to refer to the same or corresponding components across the various figures. When a particular component is discussed while referring to a figure different from the one in which the component first appears, the reference numeral and original figure will be cited for clarity.

Terms such as “first,” “second,” “top,” “bottom,” “front,” and “rear” may be used in the following description for clarity with respect to the orientation of components as shown in the figures. These terms are not intended to be limiting and may be interpreted relative to the position or orientation of the laundry cleaning tool in actual use, which may vary.

Unless otherwise specified, the singular forms “a,” “an,” and “the” include plural referents. Components may be described functionally rather than structurally where appropriate for clarity. Any features or configurations disclosed as being optional or alternative may be implemented individually or in any suitable combination, as would be understood by one of ordinary skill in the art.

The disclosed laundry cleaning tool may include body materials formed from polymeric materials that provide structural rigidity while maintaining chemical compatibility and durability requirements for household laundry applications. The tool may be configured to provide multiple functional end configurations through integrated design while maintaining ergonomic gripping characteristics during normal operational use. In some embodiments, alternative material formulations such as high-density polyethylene, polypropylene, or other rigid polymer composites may be used to achieve similar strength characteristics and chemical resistance properties.

The laundry cleaning tool may comprise an elongated body with distinct functional ends that enable controlled access to various garment areas without requiring multiple separate implements. The functional end configurations may be optimized to provide different surface geometries including rounded surfaces for shoe interiors and hooked configurations for accessing confined spaces in garments. The elongated body may be configured with grip-enhancing features positioned along its length and may incorporate ergonomic contours to provide comfortable handling during stain removal operations. The functional ends may be configured to engage with fabric surfaces while working cleaning agents into fibers, creating effective stain treatment without damaging delicate materials or causing excessive wear during repeated use.

The laundry cleaning tool may also include integrated magnetic attachment features positioned within the body structure, dimensioned to provide secure storage capabilities on common household metal surfaces including refrigerators, washing machines, or other appliances. These integrated magnetic components may provide convenient storage accessibility while eliminating the need for dedicated storage containers or mounting hardware. The magnetic features may be optimized to provide sufficient holding force for secure attachment while permitting easy removal when the tool is needed for stain removal applications.

The laundry cleaning system may include a complementary backing plate component designed to work in conjunction with the elongated tool for enhanced stain removal effectiveness. The backing plate may be configured to insert within tubular garment sections such as sleeves or pant legs, providing rigid support surfaces against which the tool can effectively work cleaning agents into fabric fibers. The plate may incorporate magnetic attachment features that enable secure connection with the tool's magnetic components for convenient storage as a single integrated unit.

The laundry cleaning tool may be configured to enable multi-functional operation through the distinct end configurations, maintaining accessibility to diverse garment areas without requiring tool changes or specialized techniques. The system may be configured to address stain removal challenges in locations including shoe interiors, seam areas, pocket corners, and other confined spaces that present accessibility challenges for conventional cleaning methods. The ergonomic grip features may be configured to accommodate comfortable handling during extended use while permitting precise control over cleaning agent application.

The laundry cleaning system may include operational configurations designed for different stain types and garment materials, accommodating both water-based and oil-based stain removal requirements. The tool may be used with various detergent formulations while maintaining chemical compatibility across the polymer construction, eliminating concerns about material degradation or adverse reactions during cleaning operations.

In use, household users may position the laundry cleaning tool according to stain location and accessibility requirements, selecting the appropriate functional end for the specific application. The tool may be operated by applying detergent to the stained area and working the cleaning agent into fabric fibers using the selected tool end while applying appropriate pressure and motion patterns. When treating stains in tubular garment sections, users may insert the backing plate within the garment to provide rigid support, position the stained area over the plate, and use the tool to work detergent into the fabric against the firm backing surface. The magnetic attachment features enable convenient storage by securing the tool to household metal surfaces or by connecting the tool and plate together as a single unit.

A household laundry room may utilize the laundry cleaning tool to address pre-treatment requirements for heavily soiled garments before machine washing. The multiple functional ends eliminate the need for maintaining separate implements for different stain removal scenarios, while the magnetic storage capability enables convenient placement on washing machine surfaces for immediate accessibility when treating fresh stains.

A shoe care enthusiast working with athletic footwear or leather shoes may benefit from the tool's ability to access interior shoe areas that conventional cleaning implements cannot effectively reach. The rounded end configuration maintains effectiveness during shoe cleaning operations, while the hooked end addresses seam areas and tight spaces around eyelets or decorative elements.

A parent managing children's clothing with frequent staining may employ the laundry cleaning tool when treating grass stains, food residue, or art supply marks on garments. The backing plate enables effective stain treatment in sleeve areas where conventional hand-based scrubbing cannot apply adequate pressure, while the tool's multiple end configurations address stains in various garment locations without requiring multiple cleaning implements.

It should be noted that the use cases described above are merely illustrative examples of how the laundry cleaning tool may be utilized, and the practical applications are not limited to these specific scenarios. The multi-functional end design and integrated magnetic storage features make the tool suitable for a wide variety of household laundry applications where accessibility, convenience, or specialized stain removal requirements provide advantages over conventional cleaning implements.

In one aspect, the present invention may include a laundry cleaning tool, including an HDPE body having a first end having a bulbous nose opposite a second end having a bullet-hooked nose. A handle portion may be disposed between the first end and the second end, wherein the handle portion defines one or more recesses configured to facilitate a hand gripping the tool. In some embodiments, the bulbous nose and the bullet-hooked nose are constructed and arranged to facilitate accessing hard-to-reach places of garments, fabrics, and shoes to apply detergents, soaps, dies, or remove stains. In some embodiments, the cleaning tool includes one or more magnets recessed within the body or the bulbous nose. In some embodiments, the cleaning tool may include a generally diamond-shaped HDPE plate also constructed and arranged to facilitate accessing hard-to-reach places of garments, fabrics, and shoes to apply detergents, soaps, dies, or remove stains. For example, the plate may be positioned within a garment beneath a stain, detergent may be applied to the stain, and the cleaning tool may be used to work the detergent into the stain using the plate as a supporting structure that prevents the garment from moving away from the cleaning tool. In some embodiments, the plate may include a second recessed magnet, such that the first recessed magnet of the cleaning tool and the second recessed magnet of the plate may be magnetically, removably attached to one another for storage, convenience, etc.

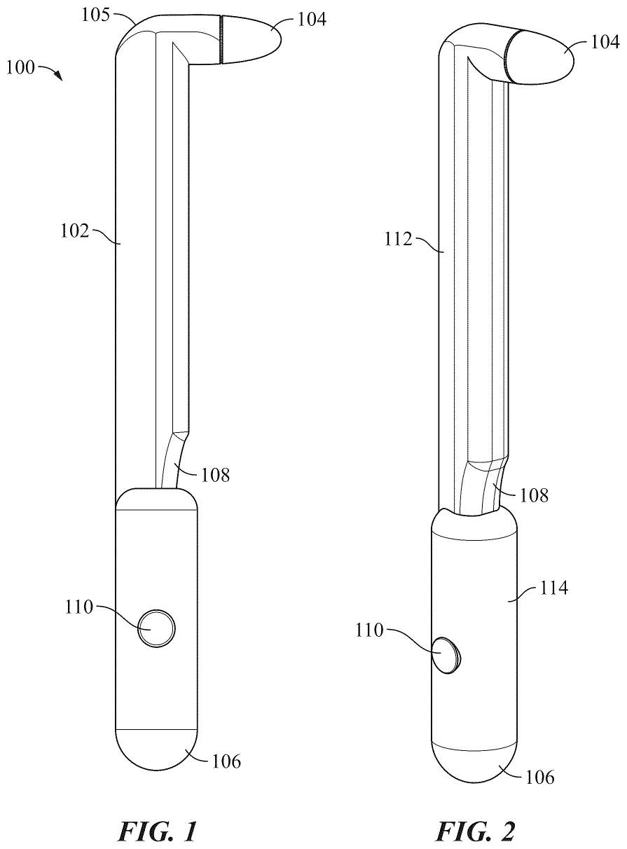

FIG. 1 illustrates a side view of a laundry cleaning tool 100 according to one embodiment of the disclosed invention. The laundry cleaning tool 100 represents a handheld implement configured for accessing diverse areas of garments and shoes while providing multiple functional end configurations for stain removal applications.

The laundry cleaning tool 100 comprises an elongated body 102 that defines the primary structural element of the tool. The elongated body 102 provides the main body structure extending longitudinally to accommodate the functional end configurations and gripping features that enable effective stain removal operations. The elongated body 102 extends from a first end to a second end opposite the first end, creating sufficient length to provide leverage during stain treatment while maintaining a manageable overall dimension for single-handed operation and convenient storage. The elongated body 102 may comprise high-density polyethylene (HDPE) that provides rigidity necessary to resist bending forces during use while maintaining chemical compatibility with common household detergents and cleaning agents. The material composition of the elongated body 102 enables repeated exposure to water, cleaning solutions, and fabric contact without degradation or loss of functional characteristics.

The laundry cleaning tool 100 further comprises a bulbous nose 106 disposed at the first end of the elongated body 102. The bulbous nose 106 provides a rounded configuration that facilitates accessing interior areas of shoes and working cleaning agents into curved surfaces. The bulbous nose 106 extends from the first end of the elongated body 102 with a smooth curved profile that prevents snagging on fabric materials while enabling controlled pressure application during stain removal operations. The rounded geometry of the bulbous nose 106 distributes applied forces across broader contact areas compared to pointed implements, reducing the risk of fabric damage while maintaining effective cleaning agent penetration into stained fibers.

The laundry cleaning tool 100 comprises an L-shaped extension 105 that extends from the second end of the elongated body 102. The L-shaped extension 105 projects outward from the elongated body 102 to create a perpendicular configuration that positions the functional end away from the main body axis. The L-shaped extension 105 forms approximately a 90-degree angle relative to the longitudinal axis of the elongated body 102, creating a horizontal projection that enables the tool to access confined spaces and recessed areas that would not be reachable with a straight linear tool configuration. The L-shaped extension 105 may comprise the same HDPE material as the elongated body 102, providing consistent material properties and chemical resistance characteristics throughout the tool structure. The perpendicular orientation of the L-shaped extension 105 relative to the elongated body 102 creates clearance for hand positioning during use while enabling the distal functional end to reach into tight spaces such as shoe interiors, seam intersections, or areas around garment closures.

The laundry cleaning tool 100 comprises a bullet-hooked nose 104 disposed at the distal end of the L-shaped extension 105. The bullet-hooked nose 104 provides a rounded or bullet-shaped terminus that completes the functional end of the L-shaped extension 105. The bullet-hooked nose 104 incorporates a smooth rounded geometry that facilitates insertion into confined spaces and enables working of cleaning agents into fabric areas that are difficult to access with conventional straight implements. The term “hooked” refers to the overall L-shaped configuration created by the L-shaped extension 105, which enables the bullet-hooked nose 104 to reach around obstacles and into recessed areas in a hooking motion, rather than requiring a straight-line approach. The bullet-hooked nose 104 provides a working surface for manipulating fabric and working detergent into stained regions while the L-shaped configuration enables access to areas around buttons, snaps, seams, and other garment features.

The combination of the L-shaped extension 105 and the bullet-hooked nose 104 creates a functional end that extends approximately perpendicular from the elongated body 102, enabling the laundry cleaning tool 100 to access hard-to-reach areas of garments and shoes. The perpendicular extension created by the L-shaped extension 105 positions the bullet-hooked nose 104 at an orientation that optimizes accessibility while providing adequate working clearance for hand positioning during stain removal operations. The structural connection between the L-shaped extension 105 and the elongated body 102 maintains sufficient rigidity to resist bending or flexing when pressure is applied through the bullet-hooked nose 104 during stain treatment, ensuring that the tool maintains its functional geometry throughout use. The L-shaped configuration enables the bullet-hooked nose 104 to hook into confined spaces, reach around obstacles, and access recessed areas that would be inaccessible with straight cleaning implements.

The elongated body 102 defines a handle portion disposed between the first end and the second end. The handle portion encompasses the central region of the elongated body 102 where users grip the tool during stain removal operations. The handle portion incorporates features that facilitate comfortable gripping while maintaining secure hand contact during use. The handle portion positions between the bulbous nose 106 and the L-shaped extension 105, providing balanced weight distribution and enabling controlled manipulation of either functional end based on the specific stain removal requirements.

The handle portion comprises a cylindrical portion 114 and a stem portion 112. The cylindrical portion 114 provides an enlarged diameter section of the handle portion that accommodates finger wrapping and palm contact during gripping. The increased diameter of the cylindrical portion 114 compared to other sections of the elongated body 102 creates a more substantial gripping surface that distributes hand forces across a larger area, reducing user fatigue during extended stain treatment sessions. The stem portion 112 extends from the cylindrical portion 114 toward the L-shaped extension 105, providing a narrower diameter section that enables alternative grip configurations and facilitates precise control when using the bullet-hooked nose 104 for detailed stain removal work in confined spaces.

The handle portion defines one or more recesses 108 that are constructed and arranged to facilitate gripping of the laundry cleaning tool 100. The recesses 108 extend into the surface of the handle portion, creating depressions or indentations that accommodate finger positioning during tool operation. The recesses 108 may be positioned along the cylindrical portion 114, the stem portion 112, or both sections of the handle portion to provide ergonomic contact points that enhance grip security. The configuration of the recesses 108 enables users to maintain secure hand contact with the laundry cleaning tool 100 even when the tool surface becomes wet or when detergent creates slippery conditions during stain removal operations. The recesses 108 may include contoured profiles that conform to finger shapes, textured surfaces that increase friction characteristics, or geometric patterns that provide visual and tactile grip indicators.

The laundry cleaning tool 100 comprises a first magnet 110 that may be at least partially recessed within the elongated body 102. The first magnet 110 positions within the body structure to provide magnetic attachment capabilities while maintaining the streamlined external profile of the tool. The first magnet 110 may be at least partially recessed within the cylindrical portion 114 of the handle portion, positioning the magnetic element in a location that provides secure attachment to metal surfaces without interfering with hand gripping during use. The recessed configuration of the first magnet 110 within the elongated body 102 protects the magnetic element from impact damage while positioning the magnetic attraction force close to the outer surface for effective attachment to household metal surfaces including washing machines, dryers, refrigerators, or other appliances. The first magnet 110 enables convenient storage by securing the laundry cleaning tool 100 to readily accessible metal surfaces in laundry areas, eliminating the need for dedicated storage containers or mounting hardware.

The elongated body 102, bulbous nose 106, L-shaped extension 105, and bullet-hooked nose 104 work together to create a multi-functional tool configuration that addresses diverse stain removal scenarios without requiring multiple separate implements. The positioning of the bulbous nose 106 and bullet-hooked nose 104 at opposite ends of the elongated body 102 enables users to select the appropriate functional end based on the specific accessibility requirements and surface geometry of the stained area. The handle portion disposed between these functional ends provides balanced tool manipulation regardless of which end is in use, while the recesses 108 maintain secure grip characteristics during different operational orientations.

The L-shaped extension 105 provides the structural element that enables the bullet-hooked nose 104 to extend approximately perpendicular from the elongated body 102, creating a tool geometry that can access areas that would be unreachable with conventional straight cleaning implements. The perpendicular configuration created by the L-shaped extension 105 enables insertion of the bullet-hooked nose 104 into shoe interiors, around garment closures, into seam intersections, and other confined spaces where stain treatment requires angular access rather than straight-line approach. The rigidity of the L-shaped extension 105 ensures that the bullet-hooked nose 104 maintains its perpendicular orientation during use, preventing deflection or bending that would reduce accessibility or make precise stain treatment difficult. The L-shaped configuration functions as a hook that enables the bullet-hooked nose 104 to reach around obstacles and access recessed areas through a hooking motion.

The first magnet 110 integrates with the overall tool configuration to provide storage functionality that complements the stain removal capabilities. When not in use, the first magnet 110 enables attachment of the laundry cleaning tool 100 to metal surfaces in laundry areas, maintaining convenient accessibility for treating fresh stains immediately upon discovery. The magnetic attachment eliminates the need to search for stored tools when time-sensitive stain treatment is required, while the secure attachment prevents the tool from being misplaced or falling from storage locations.

The bulbous nose 106 and bullet-hooked nose 104 are constructed and arranged to facilitate accessing areas of garments and shoes to apply detergent or remove stains. The bulbous nose 106 provides effectiveness when treating stains on curved surfaces such as shoe toe boxes, heels, or rounded garment areas where the smooth curved profile maintains consistent contact with the fabric surface. The bullet-hooked nose 104 provides effectiveness when accessing seam intersections, areas around buttons or snaps, pocket corners, or other confined spaces where the perpendicular extension created by the L-shaped extension 105 enables tool insertion and detergent application through a hooking motion that would not be achievable with conventional straight implements.

The material composition of the elongated body 102, L-shaped extension 105, bulbous nose 106, and bullet-hooked nose 104 provides chemical resistance characteristics that enable repeated exposure to various detergent formulations without material degradation. The HDPE construction resists swelling, softening, or chemical attack from common household cleaning agents including bleach-based products, enzyme detergents, and solvent-containing stain removers. This chemical compatibility ensures that the laundry cleaning tool 100 maintains consistent functional characteristics throughout extended service life while eliminating concerns about adverse reactions between tool materials and cleaning products.

In some embodiments, the elongated body 102 comprises HDPE with a density ranging from approximately 0.93 to 0.97 grams per cubic centimeter, providing rigidity characteristics that resist flexing during use while maintaining sufficient toughness to prevent brittle fracture if dropped or subjected to impact forces. In some embodiments, the laundry cleaning tool 100 measures approximately 122.29 millimeters in overall length from the distal end of the bulbous nose 106 to the distal end of the bullet-hooked nose 104, providing sufficient reach for accessing shoe interiors while maintaining a compact dimension suitable for drawer storage or hanging display. In some embodiments, the cylindrical portion 114 comprises a diameter of approximately 13.57 millimeters, providing adequate gripping surface for adult hand sizes while maintaining a profile that enables comfortable extended use without hand fatigue.

In some embodiments, the L-shaped extension 105 measures approximately 26.96 millimeters in length from the elongated body 102 to the distal end where the bullet-hooked nose 104 terminates, providing sufficient perpendicular offset to create effective accessibility to confined spaces while maintaining structural rigidity to resist bending during use. In some embodiments, the stem portion 112 comprises a diameter of approximately 5.00 millimeters, providing a reduced profile section that enables precise control and facilitates accessing narrow spaces with the bullet-hooked nose 104. In some embodiments, the overall height of the cylindrical portion 114 measures approximately 45.76 millimeters, providing adequate length for secure gripping while accommodating the recessed first magnet 110 within the body structure.

In some embodiments, the bulbous nose 106 comprises a hemispherical or ellipsoidal configuration with smooth surface transitions that eliminate sharp edges or corners that could snag delicate fabrics or create concentrated stress points during use. In some embodiments, the L-shaped extension 105 extends from the elongated body 102 at an angle of approximately 85 to 95 degrees, creating an orientation that optimizes accessibility to confined spaces while providing adequate working clearance for hand positioning during use. In some embodiments, the bullet-hooked nose 104 comprises a rounded or bullet-shaped profile with a smooth curved surface that facilitates insertion into confined spaces and prevents snagging on fabric materials during stain removal operations.

In some embodiments, the recesses 108 comprise elongated grooves extending along the length of the cylindrical portion 114 or stem portion 112, providing finger contact surfaces that accommodate various grip positions based on user preferences or specific stain removal operations. In some embodiments, the recesses 108 incorporate textured surfaces including knurling, dimpling, or crosshatch patterns that increase friction characteristics between user fingers and the handle portion. In some embodiments, multiple recesses 108 are distributed around the circumference of the cylindrical portion 114, enabling secure gripping regardless of tool rotation angle during use.

In some embodiments, the first magnet 110 comprises a neodymium magnet with dimensions of approximately 6 to 12 millimeters in diameter and 2 to 4 millimeters in thickness, providing sufficient magnetic attraction force to securely hold the laundry cleaning tool 100 against vertical metal surfaces without sliding or falling while enabling easy removal when the tool is needed. In some embodiments, the first magnet 110 positions within a cylindrical cavity formed in the cylindrical portion 114, with the magnet surface positioned approximately 1 to 3 millimeters below the outer surface of the elongated body 102 to protect the magnet from impact damage while maintaining effective magnetic field penetration through the remaining material thickness. In some embodiments, the first magnet 110 may be secured within the elongated body 102 using adhesive bonding, press-fitting, or ultrasonic welding techniques that create permanent attachment while maintaining the integrity of the surrounding HDPE material.

FIG. 2 illustrates a perspective view of the laundry cleaning tool 100 of FIG. 1 according to the same embodiment shown in FIG. 1. The perspective view reveals the three-dimensional spatial relationships between components and demonstrates the volumetric characteristics that enable ergonomic handling during stain removal operations.

The perspective view of the elongated body 102 reveals the cylindrical cross-sectional configuration that extends along the longitudinal axis of the tool. The circular cross-section of the elongated body 102 enables the laundry cleaning tool 100 to rotate freely in the user's hand, facilitating different grip orientations and enabling the user to adjust tool positioning without releasing and re-gripping during stain treatment operations. The smooth cylindrical profile of the elongated body 102 transitions continuously from the bulbous nose 106 through the handle portion to the connection with the L-shaped extension 105, creating a unified structural form that distributes forces along the tool length during use.

The perspective view of the bulbous nose 106 demonstrates the fully rounded three-dimensional geometry that enables effective contact with curved surfaces during stain removal. The bulbous nose 106 extends from the first end of the elongated body 102 with a hemispherical or ovoid profile that provides consistent contact area regardless of the angle of approach to the stained fabric. The three-dimensional curvature of the bulbous nose 106 eliminates sharp edges or flat surfaces that could create pressure concentration points, instead distributing applied forces smoothly across the rounded surface to prevent fabric damage during vigorous stain treatment.

The perspective view reveals the spatial relationship between the L-shaped extension 105 and the elongated body 102, showing how the perpendicular projection positions the bullet-hooked nose 104 away from the main tool axis. The L-shaped extension 105 projects horizontally from the elongated body 102 in a direction that creates clearance for hand positioning while enabling the bullet-hooked nose 104 to access confined spaces. The perspective view demonstrates that the L-shaped extension 105 maintains consistent thickness along its length, providing structural rigidity that resists twisting or bending when lateral forces are applied through the bullet-hooked nose 104 during stain treatment in tight spaces.

The bullet-hooked nose 104 positions at the distal end of the L-shaped extension 105 with a rounded terminus visible from the perspective orientation. The perspective view reveals the smooth transitional geometry between the L-shaped extension 105 and the bullet-hooked nose 104, showing how the rounded profile of the bullet-hooked nose 104 extends naturally from the extension without abrupt changes in cross-section that could create stress concentration points or catch on fabric during insertion into confined spaces.

The perspective view of the handle portion shows the three-dimensional profile of the cylindrical portion 114 and its spatial relationship with the recesses 108. The cylindrical portion 114 exhibits increased diameter compared to adjacent sections of the elongated body 102, creating a gripping zone that accommodates finger wrapping from the perspective of typical hand positioning during use. The transition from the cylindrical portion 114 to the stem portion 112 occurs with a gradual taper or stepped reduction in diameter that maintains comfortable hand contact throughout the transition zone.

The recesses 108 visible in the perspective view demonstrate their positioning along the cylindrical portion 114 at locations that correspond to natural finger placement during gripping. The perspective orientation reveals how the recesses 108 extend into the surface of the cylindrical portion 114, creating finger engagement zones that enhance grip security from multiple rotational orientations. The depth and width of the recesses 108 become apparent from the perspective view, showing depressions of sufficient dimension to accommodate fingertip contact while maintaining adequate material thickness in the cylindrical portion 114 to preserve structural rigidity.

The first magnet 110 appears in the perspective view as a circular or disc-shaped element recessed within the cylindrical portion 114. The perspective orientation reveals the flush or slightly recessed positioning of the first magnet 110 relative to the outer surface of the cylindrical portion 114, demonstrating how the magnetic element integrates into the tool structure without creating protrusions that would interfere with hand gripping or create snagging hazards during storage.

The perspective view reveals how the components of the laundry cleaning tool 100 work together to create a three-dimensional form that enables comfortable single-handed operation. The cylindrical profile of the elongated body 102 combined with the perpendicular projection of the L-shaped extension 105 creates a T-shaped or hammer-like overall configuration when viewed from certain angles, with the handle portion positioned for comfortable gripping while either the bulbous nose 106 or bullet-hooked nose 104 is directed toward the stained fabric area.

The spatial arrangement visible in the perspective view demonstrates the balanced weight distribution of the laundry cleaning tool 100, with the cylindrical portion 114 positioned approximately midway along the elongated body 102 to create a fulcrum point for comfortable tool manipulation. The perpendicular extension created by the L-shaped extension 105 positions the bullet-hooked nose 104 offset from the primary tool axis, creating rotational balance that prevents the tool from feeling front-heavy or back-heavy during extended use.

The perspective view reveals the ergonomic advantages of the cylindrical configuration, showing how the smooth continuous surfaces enable the user to rotate the tool during use to access different working angles without encountering sharp edges or discontinuities that would require re-gripping. The recesses 108 position at intervals around the cylindrical portion 114 that enable secure gripping regardless of the rotational orientation selected by the user based on the specific stain location and required tool approach angle.

In some embodiments, the cylindrical cross-section of the elongated body 102 maintains consistent diameter along portions of its length, with localized diameter variations only at the cylindrical portion 114 and the transition zones to the bulbous nose 106 and L-shaped extension 105. In some embodiments, the perspective profile reveals that the elongated body 102 comprises a wall thickness of approximately 2 to 4 millimeters, providing sufficient material to ensure rigidity while maintaining lightweight characteristics that reduce user fatigue during extended stain removal sessions.

In some embodiments, the L-shaped extension 105 visible in perspective view comprises a flattened or rectangular cross-section rather than circular cross-section, providing increased resistance to bending in the vertical plane while maintaining sufficient strength for downward pressure application through the bullet-hooked nose 104. In some embodiments, the recesses 108 extend around a portion of the circumference of the cylindrical portion 114, creating grip zones that accommodate different finger sizes and hand positions.

In some embodiments, the first magnet 110 positions on a side of the cylindrical portion 114 that faces outward when the tool is held in a natural gripping position, optimizing magnetic contact with vertical metal surfaces for storage while maintaining accessibility for hand gripping on the opposite side of the cylindrical portion 114. In some embodiments, the perspective view reveals that the bulbous nose 106 and bullet-hooked nose 104 comprise similar material thickness as the elongated body 102, creating consistent tactile feedback when either end contacts fabric surfaces during stain treatment operations.

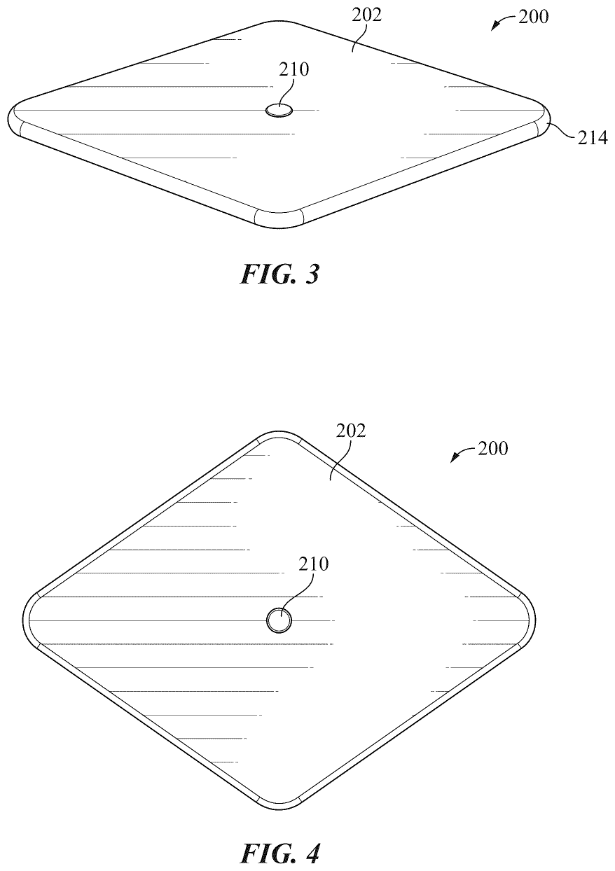

FIG. 3 illustrates a perspective view of a cleaning tool plate 200 showing the plate body and magnetic attachment feature according to some embodiments. The cleaning tool plate 200 represents a complementary component designed to work in conjunction with the laundry cleaning tool 100 described in FIGS. 1 and 2, providing rigid backing support during stain removal operations in tubular garment sections.

The cleaning tool plate 200 comprises a plate body 202 that defines the primary structural element of the backing plate. The plate body 202 provides a flat or substantially planar surface that enables insertion within garments while maintaining sufficient rigidity to serve as a backing surface during stain treatment. The plate body 202 extends in two dimensions to create a surface area sufficient to support fabric sections during stain removal while maintaining a compact size that enables insertion into sleeves, pant legs, and other tubular garment configurations. The plate body 202 may comprise HDPE that provides the rigidity necessary to resist flexing when pressure is applied through the laundry cleaning tool 100 during stain treatment, while maintaining chemical compatibility with detergents and cleaning agents. The material composition of the plate body 202 enables the cleaning tool plate 200 to function effectively as a firm backing surface that prevents fabric from moving away from the working ends of the laundry cleaning tool 100 when detergent is worked into stained areas.

The plate body 202 comprises a generally diamond-shaped configuration visible in the perspective view. The diamond-shaped configuration provides a geometry with four corners or vertices connected by four edges that form the perimeter 214 of the plate body 202. The diamond shape creates a form factor with two opposing acute angles and two opposing obtuse angles, or alternatively a square oriented at 45 degrees to create a diamond appearance. The diamond-shaped configuration provides several functional advantages including the ability to insert the plate body 202 into tubular garment sections with either narrow end leading, creating a pointed profile that facilitates entry into confined spaces while maintaining adequate surface area for backing support. The diamond shape also enables the plate body 202 to be positioned within sleeves or pant legs with the longer diagonal oriented along the garment axis, maximizing the backing surface area available for supporting fabric during stain treatment.

The plate body 202 defines a perimeter 214 having a generally curved configuration. The perimeter 214 extends around the outer boundary of the plate body 202, defining the edges that connect the corners or vertices of the diamond-shaped configuration. The curved configuration of the perimeter 214 creates smooth transitions between the vertices of the diamond shape, eliminating sharp corners or edges that could snag on fabric during insertion into or removal from garments. The curved perimeter 214 provides rounded or radiused edges that enable the cleaning tool plate 200 to slide smoothly through tubular garment sections without catching on seams, hems, or fabric weave. The curvature of the perimeter 214 distributes any contact forces along the edge across broader areas, reducing the risk of fabric damage or distortion when the plate body 202 is positioned within tight-fitting garment sections.

The cleaning tool plate 200 comprises a second magnet 210 that may be at least partially recessed within the plate body 202. The second magnet 210 positions within the plate body structure to provide magnetic attachment capabilities for connection with the first magnet 110 of the laundry cleaning tool 100 described in FIGS. 1 and 2. The second magnet 210 may be at least partially recessed below the surface of the plate body 202, creating a flush or nearly flush profile that prevents the magnetic element from protruding and snagging on fabric during insertion into garments. The recessed configuration of the second magnet 210 within the plate body 202 protects the magnetic element from impact damage while positioning the magnetic attraction force close to the surface for effective magnetic coupling with the first magnet 110. The second magnet 210 positions at a location within the plate body 202 that enables secure magnetic attachment to the cylindrical portion 114 of the laundry cleaning tool 100, creating a unified storage configuration where the cleaning tool plate 200 and laundry cleaning tool 100 remain attached as a single unit when not in use.

The plate body 202 and second magnet 210 work together to enable the cleaning tool plate 200 to serve dual functions: providing rigid backing support during stain removal operations and enabling convenient storage through magnetic attachment to the laundry cleaning tool 100. When the cleaning tool plate 200 is positioned within a garment section beneath a stained area, the plate body 202 provides a firm backing surface that prevents the fabric from flexing or moving away when the bulbous nose 106 or bullet-hooked nose 104 of the laundry cleaning tool 100 applies pressure to work detergent into the stain. After use, the second magnet 210 enables attachment of the cleaning tool plate 200 to the first magnet 110 of the laundry cleaning tool 100, creating a compact storage configuration where both components remain together for convenient access during future stain treatment operations.

The diamond-shaped configuration of the plate body 202 provides insertion advantages that enable the cleaning tool plate 200 to access various tubular garment sections. The pointed ends created by the diamond geometry facilitate initial insertion into sleeve openings or pant leg openings, with the narrow profile enabling the plate body 202 to pass through restricted openings. As the plate body 202 advances into the garment, the widening profile created by the diamond shape provides increasing backing surface area while the curved perimeter 214 maintains smooth contact with the interior garment surfaces. The symmetrical nature of the diamond shape enables insertion from either end, providing operational flexibility based on the specific garment configuration and stain location.

The cleaning tool plate 200 is constructed and arranged to be insertable within a garment to provide a rigid backing surface during use of the laundry cleaning tool 100. The flat or substantially planar profile of the plate body 202 enables the cleaning tool plate 200 to slide between fabric layers or into tubular garment sections with minimal disruption to the garment structure. Once positioned beneath a stained area, the rigidity of the plate body 202 resists the inward pressure applied through the laundry cleaning tool 100, creating a reaction surface that enables effective working of detergent into fabric fibers. Without the rigid backing surface provided by the plate body 202, the fabric would tend to flex or push away from the laundry cleaning tool 100, reducing the effectiveness of the scrubbing or rubbing action and making thorough stain treatment difficult.

The first magnet 110 of the laundry cleaning tool 100 and the second magnet 210 of the cleaning tool plate 200 are constructed and arranged to magnetically attach the cleaning tool plate 200 to the elongated body 102 of the laundry cleaning tool 100. The magnetic attraction between the first magnet 110 and second magnet 210 creates a secure connection that maintains the components as a unified assembly during storage. The magnetic attachment enables rapid separation when the cleaning tool plate 200 is needed for insertion into a garment, with simple pulling force sufficient to overcome the magnetic attraction. After stain treatment operations are complete, the magnetic attachment enables the user to reconnect the cleaning tool plate 200 to the laundry cleaning tool 100 by bringing the second magnet 210 into proximity with the first magnet 110, with the magnetic attraction automatically drawing the components together without requiring precise alignment or manual fastening operations.

The material composition of the plate body 202 provides chemical resistance characteristics that enable repeated exposure to detergents and cleaning agents without degradation. The HDPE construction resists swelling, softening, or chemical attack from household cleaning products, maintaining the flat profile and rigid backing characteristics throughout extended service life. The smooth surface finish of the plate body 202 enables easy cleaning after use, with detergent residue or stain transfer readily washing away under running water.

In some embodiments, the plate body 202 comprises HDPE with a density ranging from approximately 0.93 to 0.97 grams per cubic centimeter, providing rigidity characteristics that resist flexing when positioned within garments and subjected to pressure from the laundry cleaning tool 100. In some embodiments, the plate body 202 measures approximately 92.64 millimeters in width across the widest dimension of the diamond shape and approximately 125.03 millimeters in height along the longest diagonal, providing sufficient backing surface area to support typical stain treatment zones while maintaining a compact size suitable for insertion into sleeve and pant leg openings. In some embodiments, the plate body 202 comprises a thickness of approximately 3 to 6 millimeters, providing adequate rigidity to resist flexing while maintaining a thin profile that enables insertion into snug-fitting garment sections without excessive fabric stretching.

In some embodiments, the perimeter 214 comprises radiused edges with a radius of curvature of approximately 2 to 10 millimeters at the corners or vertices of the diamond shape, eliminating sharp points while maintaining the general diamond configuration. In some embodiments, the diamond-shaped configuration comprises a square oriented at 45 degrees, creating equal-length edges and symmetrical geometry that provides uniform backing characteristics regardless of which edge is oriented toward the stain location. In some embodiments, the diamond shape comprises elongated proportions with a length-to-width ratio of approximately 1.2 to 1.5, creating a profile optimized for insertion into tubular garment sections.

In some embodiments, the second magnet 210 comprises a neodymium magnet with dimensions of approximately 6 to 12 millimeters in diameter and 2 to 4 millimeters in thickness, matching or complementing the magnetic properties of the first magnet 110 to provide secure attachment force while enabling easy separation when needed. In some embodiments, the second magnet 210 positions near the center of the plate body 202 to provide balanced magnetic attraction regardless of the rotational orientation of the cleaning tool plate 200 relative to the laundry cleaning tool 100. In some embodiments, the second magnet 210 may be secured within the plate body 202 using adhesive bonding, ultrasonic welding, or encapsulation during molding processes that create permanent attachment while maintaining the structural integrity of the surrounding HDPE material.

In some embodiments, the plate body 202 comprises a textured surface on one or both faces to increase friction characteristics against fabric surfaces, helping to prevent the cleaning tool plate 200 from sliding within the garment during vigorous stain treatment operations. In some embodiments, the plate body 202 includes through-holes or openings near the corners or edges to facilitate insertion by enabling the user to grip the plate through the openings or to enable air circulation that reduces suction effects when inserting or removing the plate from tight-fitting garment sections.

FIG. 4 illustrates a top view of the cleaning tool plate 200 of FIG. 3 according to the same embodiment shown in FIG. 3. The top view reveals the planar surface characteristics and the diamond-shaped geometry of the plate body 202 from a directly overhead perspective.

The top view of the plate body 202 demonstrates the diamond-shaped configuration with clear delineation of the four edges that form the perimeter 214. The diamond geometry visible from the top perspective shows the symmetrical arrangement with two diagonal axes intersecting at the center of the plate body 202. The longer diagonal extends vertically in the top view orientation while the shorter diagonal extends horizontally, creating the characteristic diamond profile that facilitates insertion into tubular garment sections. The top view reveals that the diamond shape provides balanced proportions with the vertices positioned to create pointing ends that enable initial garment entry while the intermediate edge portions provide the widened profile for backing surface area.

The perimeter 214 visible in the top view shows the curved configuration along each of the four edges of the diamond shape. The curved perimeter 214 creates smooth transitions between the vertices, with each edge exhibiting a gentle outward curvature or rounded profile that eliminates sharp linear edges. The top view perspective enables clear visualization of how the perimeter 214 curves continuously around the entire boundary of the plate body 202, creating a softened diamond profile that combines the insertion advantages of pointed ends with the fabric-friendly characteristics of rounded edges.

The second magnet 210 appears in the top view as a circular element positioned within the plate body 202. The top view reveals the central or near-central positioning of the second magnet 210 within the diamond-shaped profile, showing that the magnetic element locates along or near one of the diagonal axes of the diamond configuration. The top view demonstrates that the second magnet 210 maintains adequate spacing from the perimeter 214 edges, ensuring sufficient HDPE material surrounds the magnetic element to provide structural support and prevent edge breakthrough that could expose the magnet during use.

The flat planar surface visible in the top view demonstrates the substantially two-dimensional profile of the plate body 202 that enables insertion into garments. The top view reveals that the plate body 202 maintains uniform thickness across its surface area, with no significant protrusions or recessed areas beyond the second magnet 210 cavity that would interfere with smooth insertion or create uncomfortable pressure points against fabric or skin when positioned within garments. The consistent thickness visible in the top view profile ensures that the plate body 202 provides uniform backing support across the entire diamond-shaped surface area.

The top view reveals the symmetry of the cleaning tool plate 200 along both diagonal axes of the diamond configuration. The bilateral symmetry along the major diagonal axis creates a mirror-image configuration on either side of the centerline, enabling insertion from either pointed end with equivalent functionality. The symmetry along the minor diagonal axis creates balanced backing support characteristics regardless of which face of the plate body 202 contacts the fabric during use. The symmetrical configuration visible in the top view eliminates the need for the user to orient the cleaning tool plate 200 in any specific direction during insertion or positioning, simplifying operation and reducing setup time during stain treatment procedures.

The top view perspective demonstrates how the diamond-shaped configuration creates four distinct edge regions along the perimeter 214, with each edge providing a potential leading surface during insertion into different garment configurations. The pointed vertices visible in the top view enable initial entry into sleeve or pant leg openings, while the broader intermediate edge portions provide the expanded backing surface once the cleaning tool plate 200 is fully inserted and positioned beneath the stained area.

In some embodiments, the top view reveals that the second magnet 210 positions offset from the geometric center of the diamond shape toward one of the pointed vertices, creating an asymmetric mass distribution that provides tactile indication of plate orientation during handling. In some embodiments, the plate body 202 visible in top view includes surface markings, textures, or color variations that indicate the preferred positioning orientation or provide grip-enhancing features for insertion and removal operations.

In some embodiments, the top view shows that the perimeter 214 comprises variable curvature along different edges, with the edges near the obtuse angles exhibiting greater curvature radius compared to the edges near the acute angles, optimizing the profile for specific garment insertion scenarios. In some embodiments, the diamond-shaped configuration visible in top view comprises an aspect ratio that creates an elongated diamond profile rather than a square rotated 45 degrees, providing enhanced insertion characteristics for narrow tubular garment sections.

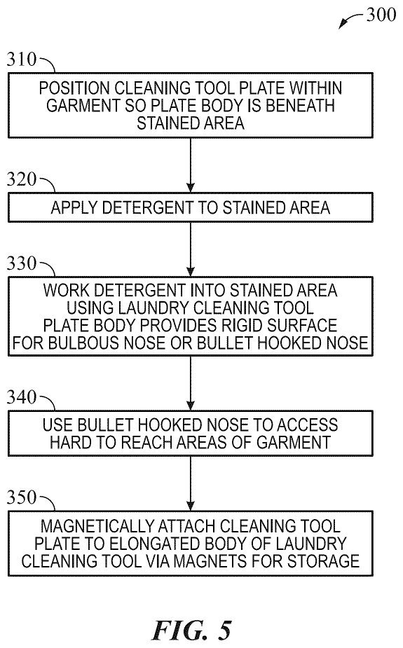

Embodiments of the present disclosure provide various methods for removing stains from garments using a laundry cleaning tool and backing plate configuration, such as described herein. Various examples of the operations performed in accordance with some embodiments of the present disclosure will now be provided with reference to FIG. 5.

FIG. 5 illustrates a flowchart 300 of an example method for removing stains from garments using the laundry cleaning tool 100 and cleaning tool plate 200 described in the previous sections. The method 300 outlines the operational sequence involved in achieving effective stain removal through the use of rigid backing support and multi-functional cleaning tool ends, ensuring proper stain treatment and convenient tool storage within household laundry applications.

The method 300 begins at operation 310, which involves positioning a cleaning tool plate within a garment such that a plate body of the cleaning tool plate is beneath a stained area. During this phase, the user inserts the cleaning tool plate 200 into a tubular section of the garment such as a sleeve or pant leg, advancing the plate body 202 through the garment opening until the plate body 202 positions directly beneath the stained area requiring treatment. The diamond-shaped configuration of the plate body 202 facilitates insertion by providing pointed ends that navigate through restricted garment openings while the curved perimeter 214 prevents snagging on fabric during advancement. The user may manipulate the garment exterior to locate the cleaning tool plate 200 and verify that the plate body 202 centers beneath the stain, creating the rigid backing surface necessary for effective subsequent cleaning operations. In some embodiments, the positioning operation includes orienting the cleaning tool plate 200 within the garment such that the longest diagonal of the diamond shape aligns with the tubular axis of the sleeve or pant leg, maximizing the backing surface area available for stain treatment. In some embodiments, the user may position the cleaning tool plate 200 by inserting it from either end of the tubular garment section based on which end provides easier access or requires less fabric manipulation.

At operation 320, the method involves applying detergent to the stained area. The user applies liquid or gel detergent directly to the stained area on the exterior surface of the garment while the cleaning tool plate 200 remains positioned beneath the stain on the interior. The detergent application may involve pouring, spraying, or dabbing the cleaning agent onto the stained fabric, creating sufficient coverage to enable penetration into the fabric fibers during subsequent working operations. The presence of the rigid plate body 202 beneath the stained area prevents the fabric from flexing away from the applied detergent, helping to contain the cleaning agent in the stain zone. In some embodiments, the detergent application includes saturating the stained area with cleaning agent to create adequate lubrication for the subsequent scrubbing or working operations. In some embodiments, the user may apply detergent formulations specifically selected for the stain type, fabric material, or color characteristics of the garment.

At operation 330, the method involves working the detergent into the stained area using a laundry cleaning tool, wherein the laundry cleaning tool comprises an elongated body having a bulbous nose at a first end and a bullet-hooked nose at a second end opposite the first end, and wherein the plate body provides a rigid surface against which the bulbous nose or the bullet-hooked nose presses the stained area during the working of the detergent into the stained area. The user selects either the bulbous nose 106 or bullet-hooked nose 104 based on the surface geometry and accessibility requirements of the stained area, positioning the selected functional end against the exterior fabric surface over the stain. The user applies pressure through the selected nose while moving the laundry cleaning tool 100 in circular, back-and-forth, or scrubbing motions that work the detergent into the fabric fibers. The rigid backing provided by the plate body 202 beneath the stain creates a reaction surface that prevents the fabric from flexing or pushing away from the applied pressure, enabling effective mechanical agitation that drives the detergent into contact with the stain particles. The bulbous nose 106 may be selected for treating stains on relatively flat or gently curved garment sections where the rounded profile provides consistent contact area, while the bullet-hooked nose 104 may be selected for accessing stains near seams, around closures, or in other areas where the perpendicular extension created by the L-shaped extension 105 provides superior accessibility. In some embodiments, the working operation continues for approximately 10 to 60 seconds per stain depending on the stain type, age, and fabric material, with the user applying pressure of approximately 2 to 10 Newtons through the selected nose to achieve effective detergent penetration without fabric damage. In some embodiments, the user alternates between the bulbous nose 106 and bullet-hooked nose 104 during the working operation to address different portions of the stained area or to vary the contact geometry for improved cleaning effectiveness.

At operation 340, the method involves using the bullet-hooked nose to access areas of the garment that are difficult to reach with the bulbous nose. Following or during the primary stain treatment at operation 330, the user may identify portions of the stained area that extend into seam intersections, around buttons or snaps, into pocket corners, or other confined spaces where the straight-line approach required by the bulbous nose 106 cannot effectively position the cleaning end against the fabric. The user repositions the laundry cleaning tool 100 to engage the bullet-hooked nose 104 with these difficult-to-reach areas, utilizing the perpendicular extension provided by the L-shaped extension 105 to insert the bullet-hooked nose 104 into the confined space. The L-shaped configuration enables the bullet-hooked nose 104 to hook around obstacles and reach into recessed areas through angular approach rather than requiring straight-line access. The user works detergent into these confined areas through the bullet-hooked nose 104 while the plate body 202 continues to provide backing support for the fabric sections being treated. In some embodiments, the operation 340 occurs simultaneously with operation 330 rather than as a separate sequential step, with the user switching between the bulbous nose 106 and bullet-hooked nose 104 as needed during continuous stain treatment. In some embodiments, the bullet-hooked nose 104 enables treatment of stains extending into areas that would otherwise require disassembly of garment closures or seam separation for adequate cleaning access.

At operation 350, the method involves magnetically attaching the cleaning tool plate to the elongated body of the laundry cleaning tool via a first magnet recessed within the elongated body and a second magnet recessed within the plate body. Following completion of the stain treatment operations, the user removes the cleaning tool plate 200 from within the garment by withdrawing the plate body 202 through the tubular opening. The user may rinse both the laundry cleaning tool 100 and cleaning tool plate 200 under running water to remove detergent residue and transferred stain material. The user then brings the second magnet 210 of the cleaning tool plate 200 into proximity with the first magnet 110 of the laundry cleaning tool 100, with the magnetic attraction automatically drawing the components together to create a unified storage assembly. The magnetic attachment maintains the laundry cleaning tool 100 and cleaning tool plate 200 as a single unit that can be stored together, preventing separation or misplacement of either component. The magnetically attached assembly may then be secured to a metal surface such as a washing machine, dryer, or refrigerator through the magnetic attraction of the first magnet 110, creating convenient storage that maintains both components readily accessible for future stain treatment operations. In some embodiments, the magnetic attachment operation occurs with the laundry cleaning tool 100 already attached to a metal storage surface, with the user simply positioning the cleaning tool plate 200 against the cylindrical portion 114 where the magnetic attraction between the first magnet 110 and second magnet 210 creates the connection. In some embodiments, the user may store the magnetically attached assembly in a drawer, cabinet, or hanging configuration rather than utilizing magnetic attachment to metal surfaces.

The method 300 provides an integrated approach to achieving effective stain removal in garments through the combination of rigid backing support and multi-functional cleaning tool configurations. The use of the cleaning tool plate 200 positioned beneath stained areas enables effective working of detergent into fabric fibers by preventing fabric deflection, while the multiple functional ends of the laundry cleaning tool 100 provide accessibility to diverse stain locations including confined spaces and recessed areas. The magnetic attachment capability enables convenient storage where both components remain together as a unified assembly, eliminating the need to search for separated components when fresh stains require immediate treatment.

The method 300 enables treatment of stains in garment locations that would be difficult or impossible to address effectively using conventional hand-based scrubbing techniques, where the lack of rigid backing enables fabric to flex away from applied pressure. The rigid backing provided by the plate body 202 creates a firm reaction surface that maintains fabric positioning during vigorous scrubbing or working motions, improving detergent penetration and mechanical agitation of stain particles. The method reduces the physical effort required for effective stain removal by enabling pressure application through the ergonomically designed handle portion rather than requiring direct hand pressure against fabric surfaces.

It is worth noting that additional operations or variations may be included in the method 300, depending on the specific requirements of the stain type, fabric material, or garment configuration. For example, the method may include operations for pre-treating particularly stubborn stains with specialized stain removers before applying general-purpose detergent at operation 320. Additionally, the method may involve operations for treating multiple separate stained areas on the same garment by repositioning the cleaning tool plate 200 to different locations and repeating operations 320 through 340 for each stain. The method may include operations for treating stains on non-tubular garment sections by positioning the cleaning tool plate 200 on one side of the fabric and working detergent through from the opposite side without inserting the plate within a tubular section. The method may involve operations for using the first magnet 110 alone to attach the laundry cleaning tool 100 to metal surfaces for storage when the cleaning tool plate 200 is not needed or is being used separately.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. Operations 310 through 350 represent a typical sequence for comprehensive stain treatment, but the specific order may vary based on user preferences, garment configurations, or stain characteristics. For example, operation 340 involving use of the bullet-hooked nose for difficult-to-reach areas may occur before, during, or after operation 330 involving general stain working operations, depending on the stain location and extent.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A laundry cleaning tool comprising:
an elongated body comprising a first end, a second end opposite the first end, and a handle portion disposed between the first end and the second end;
a bulbous nose disposed at the first end of the elongated body;
a bullet-hooked nose disposed at the second end of the elongated body, wherein the bullet-hooked nose extends from the elongated body;
one or more recesses defined by the handle portion, wherein the one or more recesses are constructed and arranged to facilitate gripping of the laundry cleaning tool; and
a first magnet at least partially recessed within the elongated body;
wherein the bulbous nose and the bullet-hooked nose are constructed and arranged to facilitate accessing areas of garments and shoes to apply detergent or remove stains.

2. The laundry cleaning tool of claim 1, wherein the elongated body comprises high-density polyethylene (HDPE).

3. The laundry cleaning tool of claim 1, wherein the handle portion comprises a cylindrical portion and a stem portion, wherein the cylindrical portion and the stem portion are each constructed and arranged to facilitate gripping of the laundry cleaning tool.

4. The laundry cleaning tool of claim 3, wherein the first magnet is at least partially recessed within the cylindrical portion of the handle portion.

5. The laundry cleaning tool of claim 1, wherein the bullet-hooked nose extends approximately perpendicular from the elongated body.

6. The laundry cleaning tool of claim 1, wherein the first magnet is constructed and arranged to magnetically attach the elongated body to an external metal surface for storage of the laundry cleaning tool.

7. The laundry cleaning tool of claim 1, further comprising a cleaning tool plate comprising:
a plate body having a perimeter; and a second magnet at least partially recessed within the plate body.

8. The laundry cleaning tool of claim 7, wherein the perimeter of the plate body is curved.

9. The laundry cleaning tool of claim 7, wherein the plate body comprises a generally diamond-shaped configuration.

10. The laundry cleaning tool of claim 7, wherein the first magnet and the second magnet are constructed and arranged to magnetically attach the cleaning tool plate to the elongated body.

11. The laundry cleaning tool of claim 7, wherein the cleaning tool plate is constructed and arranged to be insertable within a garment to provide a rigid backing surface during use of the laundry cleaning tool.

12. The laundry cleaning tool of claim 7, wherein the plate body comprises high-density polyethylene (HDPE).

13. A laundry cleaning system comprising:
a an elongated tool comprising:
an elongated body comprising a first end, a second end opposite the first end, and a handle portion disposed between the first end and the second end;
a bulbous nose disposed at the first end of the elongated body;
a bullet-hooked nose disposed at the second end of the elongated body, wherein the bullet-hooked nose extends approximately perpendicular from the elongated body;
one or more recesses defined by the handle portion, wherein the one or more recesses are constructed and arranged to facilitate gripping of the elongated tool; and
a first magnet at least partially recessed within the elongated body; and
a cleaning tool plate comprising:
a plate body having a perimeter; and
a second magnet at least partially recessed within the plate body;
wherein the first magnet and the second magnet are constructed and arranged to magnetically attach the cleaning tool plate to the elongated tool.

14. The laundry cleaning system of claim 13, wherein the elongated body and the plate body each comprise high-density polyethylene (HDPE).

15. The laundry cleaning system of claim 13, wherein the handle portion comprises a cylindrical portion and a stem portion, wherein the cylindrical portion and the stem portion are each constructed and arranged to facilitate gripping of the elongated tool.

16. The laundry cleaning system of claim 13, wherein the plate body comprises a generally diamond-shaped configuration.

17. The laundry cleaning system of claim 13, wherein the bulbous nose is constructed and arranged to access areas of shoes for cleaning and wherein the bullet-hooked nose is constructed and arranged to access hard-to-reach areas of garments and shoes.

18. A method of removing stains from a garment, the method comprising:
a positioning a cleaning tool plate within the garment such that a plate body of the cleaning tool plate is beneath a stained area of the garment;
applying detergent to the stained area; and
working the detergent into the stained area using a laundry cleaning tool, wherein the laundry cleaning tool comprises an elongated body having a bulbous nose at a first end and a bullet-hooked nose at a second end opposite the first end;
wherein the plate body provides a rigid surface against which the bulbous nose or the bullet-hooked nose presses the stained area during the working of the detergent into the stained area.

19. The method of claim 18, further comprising magnetically attaching the cleaning tool plate to the elongated body of the laundry cleaning tool via a first magnet recessed within the elongated body and a second magnet recessed within the plate body.

20. The method of claim 18, wherein the working the detergent into the stained area comprises using the bullet-hooked nose to access areas of the garment that are difficult to reach with the bulbous nose.
